(19) United States
(12) Patent Application Publication
(10) Pub. No.: US 2026/0009946 A1
(43) Pub. Date: Jan. 8, 2026

(54) MULTICORE OPTICAL FIBER WITH IMPROVED CROSSTALK

(71) Applicant: STERLITE TECHNOLOGIES LIMITED, Gurugram (IN)

(72) Inventors: Srinivas Kumar Munige, Gurugram (IN); Apeksha Malviya, Gurugram (IN); Ranjith Balakrishnan, Gurugram (IN); Anand Pandey, Gurugram (IN)

(21) Appl. No.: 19/260,328

(22) Filed: Jul. 4, 2025

(30) Foreign Application Priority Data
Jul. 4, 2024 (IN) IN202411051296

(51) Int. Cl. G02B 6/02

(52) U.S. Cl. CPC G02B 6/02042; G02B 6/02028

(57) ABSTRACT

The present invention provides multicore optical fiber (100, 200, 300, 400, 500, 600, 700, 800) with a cladding region (102), one or more trench regions (104) in the cladding region (102). In particular, the cladding region (102) has at least one core region of one or more core regions (106) on both sides of the one or more trench regions (104). Further, the one or more trench regions (104) is not adjacent to the at least one core region of the one or more core regions (106).

### CROSS-REFERENCE TO RELATED APPLICATIONS

The present application claims the benefit of Indian Application No. IN202411051296 titled “MULTICORE OPTICAL FIBER WITH IMPROVED CROSSTALK” filed by the applicant on Jul. 4, 2024, which is incorporated herein by reference in its entirety.

### FIELD OF THE INVENTION

Embodiments of the present invention relate to the field of wireless communication networks of optical fibres, and in particular, relates to a multicore optical fiber having improved crosstalk.

### DESCRIPTION OF THE RELATED ART

Telecommunications networks include access networks where end-user subscribers connect to service providers. With the advancement of science and technology, various modern technologies are being employed for communication purposes. To meet increasing consumer demands, bandwidth requirements for providing high speed data and video services over access networks are growing rapidly. Being one of the most important modern communication technologies, the optical fiber communication technology uses a variety of optical fiber cables.

Optical fiber cables utilize optical fibers to transmit signals such as voice, video, image, data or information. Optical fibers are strands of glass fiber processed so that light beams transmitted through the glass fiber are subject to total internal reflection wherein a large fraction of the incident intensity of light directed into the fiber is received at the other end of the fiber.

Generally two main categories of optical fibers exist: multimode fibers and single-mode fibers. Conventionally, step-index fibers, also called SMF fibers (“Single Mode Fibers”) are used as line fibers for optical fiber transmission systems in which a single mode of light is transmitted as a carrier for propagation at a time. In a single-mode optical fiber, the signal propagates in a fundamental LP01 mode that is guided in the fiber core, while the higher order modes (e.g., the LP11 mode) are strongly attenuated. The core of a single-mode optical fiber typically has a diameter of between about 6 microns and 9 microns. These fibers exhibit a chromatic dispersion and a chromatic dispersion slope corresponding to specific telecommunication standards.

However, such SMFs have associated bandwidth limitations. Additionally, such SMFs exhibit non-linear effects due to increase in the data transmission rate beyond a transmission capacity limit. The non-linear effects can further result in low optical signal to noise ratio (OSNR). The bandwidth limitations can be reduced by designing multi-core optical fibers that have multiple glass cores to transmit multiple optical signals. Additionally, by increasing the number of channels per fiber and by optimizing the number of cores and a design of the multi-core optical fiber the bandwidth limitations can be reduced.

A multi-core fiber (MCF) typically comprises a central core surrounded by several satellite cores in a radial pattern surrounding the central core. The multi-core fiber can have multiple glass cores that are surrounded by a glass cladding. Each of the central and satellite cores is potentially a light carrying path, and the MCF thus provides multiple parallel paths for optical signal transmission and/or reception in a single fiber. Generally, an alpha value of the refractive index profile of the core has a significant impact on distribution of light inside the core and thus effects an effective refractive index of guiding modes in the optical fibers.

Generally, the optical fibers are connected to each other via a connector assembly. Cross talk is a very important parameter in multicore fiber tincrease the number of cores inside the multicore fiber, core pitch needs to be decreased which leads to high crosstalk. Known methods in the existing multicore fiber to control the crosstalk on the central core is to envelop each core of the multicore fiber with a trench region. The formation of the trench region can provide a strict limitation of increasing the number of cores in the multicore fiber because it is a costly process and along with the cost the formation of trench in the cores does not completely stop the light to nearby cores and cannot control crosstalk in effective and efficient way.

US patent application ‘US20110222828A1’ and ‘U.S. Pat. No. 8,965,165’ discloses a multicore fiber such that the central core having six neighboring (equidistance) cores, this leads to the worst crosstalk performance of the central core. As a result, the central core will not be efficient for communication if compared with the non-central cores. In every possible design of multicore fiber having a central core, there are multiple surrounding cores which impacts the performance of the central core.

Another US patent application ‘US20220276430A1’, discloses four core fibers with direct electromagnetic interference between the cores and each core has three surrounding cores which increases crosstalk between the cores.

However, there are a few drawbacks in the currently similar technologies providing multicore optical fibers. The multicore optical fibers provided by the current technologies have higher sensitivity to dispersion. The higher sensitivity to dispersion can stretch or flatten an initially sharply defined binary pulses of information. Such degradation can make the optical signals (1s and 0s) more difficult to distinguish from each other at the far end of the multicore optical fiber. Moreover, a requirement of low total crosstalk in interconnects limits the density of cores within the multi-core optical fiber, and thus the capacity scaling, compactness, and cost of the interconnect formed from the multi-core optical fiber.

Thus, there is a need for a multicore fiber where the performance of the central core region along with the non-central core regions can be improved without impacting the waveguide properties of each core of the multicore fiber.

Accordingly, to overcome the disadvantages of the prior arts, there is a need for a technical solution that overcomes the above-stated limitations in the prior arts. The present invention provides a multicore optical fiber having improved crosstalk.

### SUMMARY OF THE INVENTION

Embodiments of the present invention relates to a multicore optical fiber comprising a cladding region comprising: one or more trench regions in the cladding region; and one or more core regions such that there is at least one core region on both sides of the one or more trench regions. Further, the one or more trench regions are not adjacent to the one or more core regions

In accordance with an embodiment of the present invention, the one or more core regions comprise a central core region and one or more non-central core regions.

In accordance with an embodiment of the present invention, the one or more trench regions separate the central core region and the one or more non-central core regions. In particular, the one or more trench regions and the one or more core regions are separated by a radial distance in the range of 5 micrometres to 10 micrometres. Moreover, each core region of the one or more core regions is surrounded by a core trench region adjacent to the core region.

In accordance with an embodiment of the present invention, multicore optical fiber, further comprises one or more buffer regions disposed between the one or more core regions and the one or more core trench regions.

In accordance with an embodiment of the present invention, multicore optical fiber further comprising one or more peripheral trench regions. In particular, the one or more peripheral trench regions envelop the one or more core regions.

In accordance with an embodiment of the present invention, the cladding region comprises at least one inner cladding region and an outer cladding region. In particular, the outer cladding region has an outer cladding thickness of less than or equal to 25 micrometres.

In accordance with an embodiment of the present invention, the central core region is surrounded by a central core trench region and the non-central core regions are non-trenched. Further, the central core region is non-trenched and the non-central core regions are surrounded by a core trench region.

In accordance with an embodiment of the present invention, the distance between two nearest cores of the multicore optical fiber is in the range of 35 micrometres to 40 micrometres.

In accordance with an embodiment of the present invention, multicore optical fiber comprises a central core region, a first plurality of non-central core regions disposed at a first radial distance from a geometrical centre of the multicore fiber; and a second plurality of non-central core regions disposed at a second radial distance from the geometrical centre of the multicore fiber. Further, the one or more trench regions separate the central core region, the first plurality of non-central core regions, and the second plurality of non-central core regions.

In accordance with an embodiment of the present invention, the multicore fiber has at least one of:
(i) a crosstalk of less than or equal to −70 dB per 10 km,
(ii) a mode field diameter in the range of 8.1 micrometres to 9.1 micrometres at 1310 nm, and
(iii) a mode field diameter in the range of 9.5 micrometres to 13 micrometres at 1550 nm.

In accordance with an embodiment of the present invention, the one or more trench regions have a trench relative refractive index in the range of −0.4% to −0.6%. Further, the one or more core trench regions have a core trench relative refractive index in the range of −0.25% to −0.4%.

The foregoing objectives of the present invention are attained by employing a multicore optical fiber having improved crosstalks.

### BRIEF DESCRIPTION OF DRAWINGS

To describe the technical solutions in the embodiments of the present invention or in the prior art more clearly, the following briefly describes the accompanying drawings required for describing the embodiments or the prior art. Apparently, the accompanying drawings in the following description merely show some embodiments of the present invention, and a person of ordinary skill in the art can derive other implementations from these accompanying drawings without creative efforts. All of the embodiments or the implementations shall fall within the protection scope of the present invention.

FIG. 1 is a pictorial snapshot illustrating a cross-sectional view of a multicore fiber in accordance with an embodiment of the invention;

FIG. 2 is a pictorial snapshot illustrating a cross-sectional view of another multicore fiber in accordance with an embodiment of the invention;

FIG. 3 is a pictorial snapshot illustrating a cross-sectional view of yet another multicore fiber in accordance with an embodiment of the invention;

FIG. 4 is a pictorial snapshot illustrating a cross-sectional view of yet another multicore fiber in accordance with an embodiment of the invention;

FIG. 5 is a pictorial snapshot illustrating a cross-sectional view of yet another multicore fiber in accordance with an embodiment of the invention;

FIG. 6 is a pictorial snapshot illustrating a cross-sectional view of yet another multicore fiber in accordance with an embodiment of the invention;

FIG. 7 is a pictorial snapshot illustrating a cross-sectional view of yet another multicore fiber in accordance with an embodiment of the invention;

FIG. 8 is a pictorial snapshot illustrating a cross-sectional view of yet another multicore fiber in accordance with an embodiment of the invention.

The optical fiber is illustrated in the accompanying drawings, which like reference letters indicate corresponding parts in the various figures. It should be noted that the accompanying figure is intended to present illustrations of exemplary embodiments of the present invention. This figure is not intended to limit the scope of the present invention. It should also be noted that the accompanying figure is not necessarily drawn to scale.

### DESCRIPTION OF EMBODIMENTS

Those skilled in the art will be aware that the present invention is subject to variations and modifications other than those specifically described. It is to be understood that the present invention includes all such variations and modifications. The invention also includes all such steps, features, compositions and compounds referred to or indicated in this specification, individually or collectively, and any and all combinations of any or more of such steps or features.

### Definitions

For convenience, before further description of the present invention, certain terms employed in the specification, and examples are collected here. These definitions should be read in the light of the remainder of the invention and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”. Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

The following brief definition of terms shall apply throughout the present invention:

Term “optical fiber” as used herein refers to a light guide that provides high-speed data transmission. The optical fiber has one or more glass core regions and one or more glass cladding regions. The light moving through the glass core regions of the optical fiber relies upon the principle of total internal reflection, where the glass core regions have a higher refractive index (n1) than the refractive index (n2) of the glass cladding region of the optical fiber.

Term “optical fiber cable” as used herein refers to a cable that encloses one or more optical fibers.

Term “Refractive Index (RI) profile: The refractive index profile of an optical fiber as used herein is referred to as the distribution of refractive indexes in the optical fiber from the core to the outmost cladding layer of the optical fiber. Based on the refractive index profile, the optical fiber may be conFig.ured as a step index fiber. The refractive index of the core of the optical fiber is constant throughout the fiber and is higher than the refractive index of the cladding. Further, the optical fiber may be configured as a graded index fiber, wherein the refractive index of the core gradually varied as a function of the radial distance from the centre of the core.

Term “relative refractive index” as used herein is defined as

$$Δ \% = 100 \times \frac{{ni}^{2} - {n}^{2}}{2 {ni}^{2}} , ,$$

where
ni is maximum refractive index in region i of an optical fiber unless otherwise specified, and n is the average refractive index of an undoped region of the optical fiber. As used herein, the values of the relative refractive index are given in units of “%”, unless otherwise specified. In some cases where the refractive index of a region is less than the average refractive index of an undoped region, the relative refractive index percentage is negative, and the region is referred as a trench region.

Term “down doping” as used herein refers to adding doping materials to facilitate decrease in the refractive index of a particular layer or part of optical fiber. The materials conFig.ured to facilitate down-doping are known as down-dopants such as Fluorine. The down doping is done to form a low RI region i.e., trench region.

Term “up doping” as used herein refers to adding doping materials to facilitate increase in the refractive index of a particular layer or part of optical fiber. The materials conFigured to facilitate up-doping are known as up-dopants such as Germanium, Chlorine.

Term “un doped” or “unintentionally doped” as used herein refers to a region of the optical fiber that contains a dopant not intentionally added to the region during fabrication, but Termdoes not exclude low levels of background doping that may be inherently incorporated during the fabrication process. Such background doping levels are low in that they have an insignificant effect on the refractive index of the undoped region.

Term “multicore fiber” as used herein refers to an optical fiber having multiple core regions, each capable of communicating light signals between transceivers including transmitters and receivers which may allow for parallel processing of multiple signals. The multicore fiber may be used for wavelength division multiplexing (WDM) or multi-level logic or for other parallel optics of spatial division multiplexing. The multicore fiber may advantageously be aligned with and connected to various devices in a manner that allows for easy and reliable connection so that the plurality of core regions are aligned accurately at opposite terminal ends with like communication paths in connecting devices.

Term “heterogeneous multicore fiber” as used herein refers to a multicore fiber having a different RI profile of the core. When the RI profile of two cores are different, this means both the cores have different propagation constant, and because of different propagation constant there is a phase mismatch between the two cores i.e., Aβ≠0 which leads to reduction in cross talk between the two cores. In a straight fiber, heterogeneous multicore fiber achieves less crosstalk (XT) as compared to the known homogeneous multicore fiber known in the art.

Term “pitch” as used herein refers to a core to core spacing between adjacent cores in a multicore fiber. In other words, pitch is defined as a distance between the central point of two nearest cores.

Term “pitch to diameter ratio” as used herein refers to a ratio of distance between two core and the clad diameter (i.e., the glass diameter) of the optical fiber is defined as pitch to diameter ratio. The pitch to diameter ratio is utmost important in multicore fiber because of a greater number of core regions, the cross talk between cores increases if the multicore fiber has not been optimally designed.

Term “crosstalk” as used herein refers to a major impairment of optical communication networks utilizing WDM transmission. Crosstalk in optical networks occurs when the optical power associated with one channel starts appearing in another channel or adjacent channel. In MCF, the crosstalk arises from unwanted coupling between the multiple cores.

Term “predefined lattice” as used herein refers to a polynomial having four or more than four sides. The predefined lattice can also be a circular lattice.

Term “trench assisted core region” as used herein is a core region immediately surrounded by a trench region is defined as trench assisted core region. In other words, the trench region is disposed adjacent to the core region. The trench assisted core region is formed by manufacturing a trenched core rod while preparing a multicore glass preform assembly. The trenched core rod comprises an up-doped region and a down-doped region surrounding the up-doped region.

Term “non-trenched core region” as used herein refers to a core region that is only doped with an up dopant and there is no low refractive index region or trench region surrounding the core region. The non-trenched core region is formed by manufacturing a core rod while preparing a multicore glass preform assembly. The core rod comprises an up-doped region and a pure silica region surrounding the up-doped region. Further, the pure silica region of the core rod gets fused with pure silica cladding which makes the non-trenched core region free from the trench region as well as buffer region.

Term “buffer region” as used herein refers to a region having low width which is un doped (i.e., pure silica). The radial thickness of the buffer region is less than 0.5 μm. The buffer region is not an intentional un doped region between the up doped core region and the trench region. The tolerance value of the buffer region is less than 0.5 μm which may develop around the core region because of uncontrolled process parameters. In an ideal scenario, the width of the buffer region is zero.

Term “leakage loss” as used herein refers to loss due to mode leak in an optical fiber that adds to an attenuation of the optical fiber. The leakage loss is calculated using finite element analysis method where the losses are calculated in the fiber in straight condition. In multicore fiber, leakage loss is very critical for the outer cores which are near to the outer cladding interface.

Term “glass diameter of the optical fiber” as used herein refers to a diameter of a bare fiber that is an uncoated fiber drawn by melting a glass preform in a draw tower. Further, the bare fiber is coated with one or more coating layers (i.e., a primary coating layer and/or a secondary coating layer).

Term “mode field diameter (MFD)” as used herein refers to the diameter of the spread of electric field distribution in propagation mode (light path). Light usually passes through the core region. However, in the case of a single-mode optical fiber, the light leaks into the cladding region. Therefore, single-mode optical fibers are specified by MFD rather than core diameter. MFD is slightly greater than the core diameter. Each core of the multicore fiber exhibits the property of single mode fiber.

Term “cable cut off wavelength” as used herein refers to a parameter of single-mode optical fibers. An optical fiber cannot be a single-mode fiber if it is used at a wavelength shorter than the cable cut-off wavelength, which is determined by optical fiber structure, involving refraction index distribution and core diameter. Each core of the multicore fiber exhibits the property of single mode fiber.

Term “macro bend loss” as used herein refers to losses induced in bends around mandrels (or corners in installations), generally more at the cable level or for fibers. The macro bend loss occurs when the fiber cable is subjected to a significant amount of bending above a critical value of curvature. The macro bend loss is also called large radius loss. Each core of the multicore fiber exhibits the property of single mode fiber.

Term “micro bend loss” as used herein refers to a loss in an optical fiber that relates to a light signal loss associated with lateral stresses along a length of the optical fiber. The micro bend loss is due to coupling from the optical fiber's guided fundamental mode to lossy modes or cladding modes. Each core of the multicore fiber exhibits the property of single mode fiber.

Term “core multiplication factor” as used herein refers to a Total effective area of cores/Area of cladding

$$= N \times ( Aeff / ( π * ( CD / 2 ) \hat{} 2 )$$

Where N=no. of cores in the multicore fiber.
Aeff=effective mode area in one core
CD=cladding diameter.

Term “effective refractive index (RI)” as used herein refers to a ratio between the propagation constant in the optical fiber along the propagation direction and the propagation constant in vacuum.

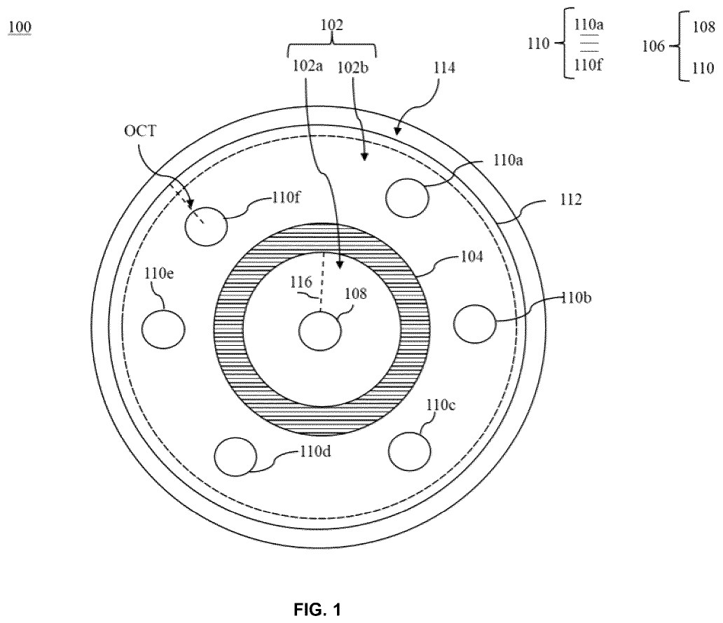

FIG. 1 is a pictorial snapshot illustrating a cross-sectional view of a multicore fiber 100. In particular, the multicore fiber 100 may have one or more trench regions that are adapted to isolate one or more central core regions and one or more non-central core regions to improve crosstalk along with achieving optimized waveguide parameters of the cores. Moreover, the one or more trench regions may be adapted to isolate a first plurality of non-central core regions and a second plurality of non-central core regions. Further, the multicore fiber 100 may have a down doped mid cladding region (i.e., trench region) such that at least one core region may be disposed on both sides of the mid cladding region. Furthermore, the multicore fiber 100 may have an inner cladding region and an outer cladding region such that the one or more trench regions isolate one or more core regions disposed in the inner cladding region and one or more core regions disposed in the outer cladding region.

In accordance with an embodiment of the present invention, the multicore fiber 100 may have a cladding region 102, one or more trench region 104, one or more core regions 106. In particular, the one or more core regions 106 may have a central core region 108 and one or more non-central core regions 110 such that both the central core region 108 and the one or more non-central core regions 110 are separated by the one or more trench regions 104 in the cladding region 102. Moreover, the one or more trench regions 104 disposed in the cladding region 102 may significantly reduce the cross talk by stopping the leakage of optical signal to nearby cores without impacting the waveguide properties of one or more core regions 106. Further, the one or more trench regions 104 disposed in the cladding region 102 may act as a barrier to isolate a set of core region of the one or more core regions 106 from other core regions of the one or more core regions 106 which is very helpful in developing high mode field diameter (MFD) multicore optical fiber compliant with ITUT G652D and G.654E along with improvements in the crosstalk. Furthermore, the one or more trench regions 104 may facilitate in manufacturing of the multicore fiber 100 with high number of core regions (for example thirteen and nineteen core regions).

In accordance with an embodiment of the present invention, the multicore fiber 100 has the cladding region 102, the one or more trench region 104, the one or more core regions 106. Particularly, the one or more core regions 106 may have the central core region 108 and the one or more non-central core regions 110 of which first through sixth non-central core regions 110a-110f are shown.

Although FIG. 1 is a pictorial snapshot illustrating that the one or more non-central core regions 110 has six non-central core regions (i.e., the first through sixth non-central core regions 110a-110f), it will be apparent to a person skilled in the art that the scope of the present invention is not limited to it. In various other aspects of the present invention, the one or more non-central core regions 110 may have any number of non-central core regions, without deviating from the scope of the present invention. In such a scenario, each non-central region is configured to perform one or more operations in a manner similar to the operations of the first through sixth non-central core regions 110a-110f as described above.

Further, the central core region 108 and the one or more non-central core regions 110 may be non-trenched core regions. And, the cladding region 102 may have a cladding diameter less than or equal to 125±0.7 μm.

In accordance with an embodiment of the present invention, the cladding region 102 may have at least one inner cladding region 102a and an outer cladding region 102b. In particular, the inner cladding region 102a and the outer cladding region 102b may be separated by the trench region 104 as shown in FIG. 1.

The outer cladding thickness (OCT) of the multicore fiber 100 may be less than or equal to 25 micrometres (μm). Alternatively, outer cladding thickness (OCT) of the multicore fiber 100 may vary. In particular, OCT is defined as a distance between a central point of the non-central core region 110 and an outer periphery of the outer cladding region 102b. Moreover, OCT is a very important parameter while designing the multicore fiber 100 to avoid leakage loss in the multicore fiber 100.

In accordance with an embodiment of the present invention, the multicore fiber 100 may have one or more coating layers 114. In particular, one or more coating layers 114 may include a primary layer, a secondary layer, and an ink layer.

The one or more coating layers may have a coating diameter in a range of 130 μm to 165 μm. Alternatively, the one or more coating layers may have a coating diameter in a range of 160 μm to 250 μm.

In accordance with an embodiment of the present invention, the multicore fiber 100 may have a single coating layer 114 having a coating diameter less than or equal to 160 μm.

In alternative embodiment of the present invention, the multicore fiber 100 may have a crosstalk of less than or equal to −70 Decibel (dB) per 10 Kilometres (km). Further, the multicore fiber 100 may have a mode field diameter in a range of 8.1 μm to 9.1 μm at a wavelength of 1310 nanometres (nm). Furthermore, the multicore fiber 100 may have a mode field diameter in a range of 9.5 μm to 13 μm at a wavelength of 1550 nm.

In accordance with an embodiment of the present invention, the multicore fiber 100 of the present invention has a higher core density that results in a lower pitch to diameter ratio. The multicore fiber 100 of the present invention is designed in such a way that even in seven core fiber, when the central core region 108 is surrounded by at least six cores, the crosstalk of the central core region 108 is controlled by isolating the central core region 108 with the trench region 104 in the cladding region 104.

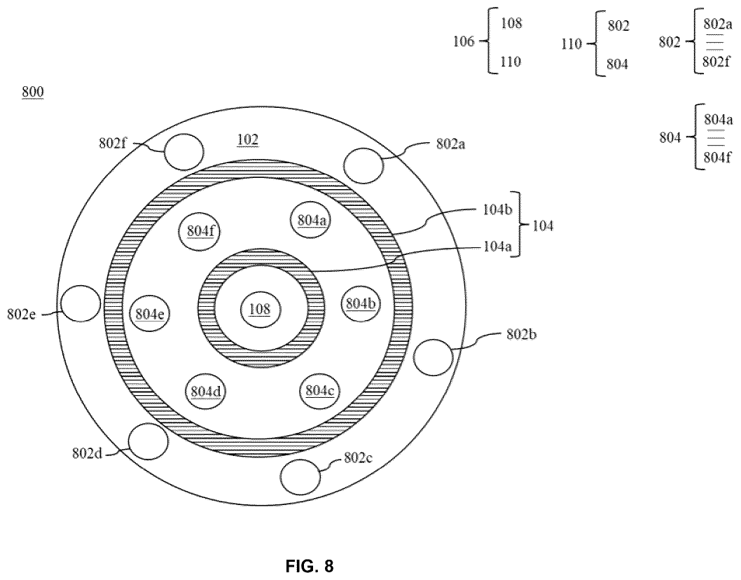

In accordance with an embodiment of the present invention, when one or more core regions 106 has 13 core regions (as shown in FIG. 8). Particularly, each of the one or more trench regions 104 has first and second trench regions 104a and 104b in the cladding region 102 that isolates the one or more core regions 106 from each other. Further, due to trench in the cladding, crosstalk between the central core and the non-central cores are reduced significantly.

In accordance with an embodiment of the present invention, the multicore fiber 100 may have a central axis such that the central core region 108 and the one or more non-central core regions 110 may be disposed along the central axis running longitudinally, i.e., generally parallel to the central axis.

Further, the multicore fiber 100 may be designed to employ space division multiplexing (SDM) technique to transmit a plurality of optical signals through the central core region 108 and the one or more non-central core regions 110 simultaneously. The one or more trench regions 104 (hereinafter individually referred to and designated as “the trench region 104”) may be disposed in the cladding region 102 such that at least one core region of the one or more core regions 106 may be disposed on both side of the trench regions 104.

In accordance with an embodiment of the present invention, the trench region 104 effectively reduces the interference between the neighboring core regions as the electromagnetic interference from a number of neighbors for each core region gets reduced; the crosstalk performance of each core region may improve significantly. In particular, the trench region 104 in the cladding 102 of the multicore fiber 100 may improve the leakage loss and bend performance of the multicore fiber 100. Moreover, the central core region 108 of the one or more core regions 106 and the one or more non-central core regions 110 of the one or more core regions 106 may be disposed on both sides of the trench region 104. Further, the trench region 104 may not be adjacent to the at least one core region of the one or more core regions 106.

In accordance with an embodiment of the present invention, the immediate trench region are formed adjacent to the core region while manufacturing of multicore fiber preform assembly where a core rod is prepared which includes both the up-doped core region and a trench region where the trench region is immediate to the up-doped core region. In particular, the one or more trench region 104 is formed while preparing the cladding region 102 such that the one or more trench region 104 is part of cladding region 102 of the multicore fiber 100. Moreover, the trench region 104 may not be adjacent to the central core region 108 and the one or more non-central core regions 110. Further the trench region 104 may be adapted to separate the central core region 108 and the one or more non-central core regions 110.

In accordance with an embodiment of the present invention, the trench region 104 and the one or more core regions 106 may be separated by a radial distance. Particularly, the radial distance between the trench region 104 and the one or more core regions 106 may be in a range of 5 micrometres (μm) to 10 μm. The radial distance is defined as a shortest distance between an outer boundary of the one or more core regions 106 and the trench region 104. The radial distance may be calculated by measuring the thickness of the pure silica region between the one or more core regions 106 and the trench region 104.

In an exemplary example, the radial distance 116 between the central core region 108 and the trench region 104 is shown in FIG. 1. The radial distance between the trench region 104 and the one or more core regions 106 may be optimised as per the disclosed range to improve the bend characteristics of the multicore fiber 100 along with no impact on the crosstalk and waveguide parameters of each core regions 106 of the multicore fiber 100. Further, each pair of adjacent core regions of the one or more core regions 106 may have a distance (hereinafter referred to and designated as pitch).

In accordance with an embodiment of the present invention, the pitch may be in a range of 35 μm to 40 μm.

In accordance with an embodiment of the present invention, the one or more core regions 106 may have a core relative refractive index (Δ_{core}), a core radius (R_{core}) and a core alpha (α_{core}). The core relative refractive index may be in a range of 0.55% to 0.66%.

In accordance with an embodiment of the present invention, the core radius of the one or more core regions 106 may be in a range of 4.4 μm to 4.7 μm. The core alpha of the one or more core regions 106 may be in a range of 3 to 9.

In accordance with an embodiment of the present invention, the trench regions 104 may have a trench relative refractive index (Δ_{trench}), a trench radius (R_{trench}) and a trench thickness (T_{trench}). The trench relative refractive index of the trench region 104 may be in a range of −0.4% to −0.6%.

In accordance with an embodiment of the present invention, the trench radius of the trench region 104 may be in a range of 13 μm to 20 μm.

In accordance with an embodiment of the present invention, the trench thickness of the trench region 104 may be in a range of 4 μm to 6 μm.

In accordance with an embodiment of the present invention, the cladding region 102 may have a cladding radius (R_{clad}), a cladding relative refractive index (Δ_{clad}). The cladding radius of the cladding region 102 may be in a range of 40 μm to 75 μm.

In accordance with an embodiment of the present invention, the cladding relative refractive index of the cladding region may be in a range of −0.005% to 0.005%.

In accordance with an embodiment of the present invention, the multicore fiber 100 may have one or more peripheral trench regions 112. In particular, the one or more peripheral trench regions 112 may be adapted to envelop the one or more core regions 106. Further, the one or more peripheral trench regions 112 may be adapted to envelop the central core region 108 and the one or more non-central core regions 110.

In one or more exemplary aspects of the present invention, the multicore fiber 100 having all the core regions 106 of non-trenched type may depict the attributes specified in Table 1.

TABLE 1

| | | | |
|---|---|---|---|
| Attributes | Example 1 | Example 2 | Example 3 |

| Δ_{core} | 0.55% | | 0.65% | | 0.55% | |
|---|---|---|---|---|---|---|
| R_{core} | 4.5 | μm | 4.6 | μm | 4.5 | μm |
| α_{core} | 3 | | 7 | | 9 | |
| Δ_{trench} | −0.4% | | −0.6% | | −0.45% | |
| R_{trench} | 15 | μm | 13 | μm | 20 | μm |
| T_{trench} | 5 | μm | 4 | μm | 6 | μm |
| R_{clad} | 62.5 | μm | 62.5 | μm | 75 | μm |
| Δ_{clad} | 0 | | 0.005% | | −0.005% | |
| MFD (at 1310 nm) | 8.62 | μm | 8.61 | μm | 8.62 | μm |
| MFD (at 1550 nm) | 9.42 | μm | 9.51 | μm | 9.56 | μm |
| Pitch | 30 | μm | 35 | μm | 40 | μm |
| OCT | 32.5 | μm | 27.5 | μm | 35 | μm |
| Crosstalk (dB/10 | −70 | | −82 | | −100 | |
| km) | | | | | | |
| Zero dispersion | 1312 | nm | 1302 | nm | 1312 | nm |
| wavelength (ZDW) | | | | | | |
| Cable cut-off | 1175 | nm | 1242 | nm | 1175 | nm |

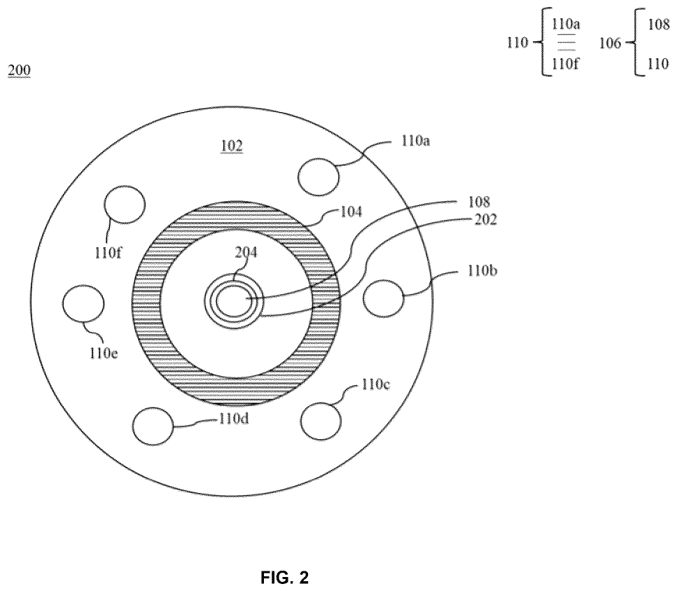

FIG. 2 is a pictorial snapshot illustrating a cross-sectional view of another multicore fiber 200. The multicore fiber 200 may be structurally and functionally similar to the multicore fiber 100 of FIG. 1, however, the central core region 108 of the multicore fiber 200 may be a trench assisted central core region and the one or more non-central core regions 110 are non-trenched core regions. In particular, the multicore fiber 200 has the trench region 104 disposed in the cladding region 102. Moreover, the central core region 108 may be surrounded by a central core trench region 202. Further, the multicore fiber 200 may have one or more buffer regions 204 disposed between the central core region 108 and the central core trench region 202. The central core trench region 202 may have a core trench relative refractive index in range of −0.25% to −0.4%.

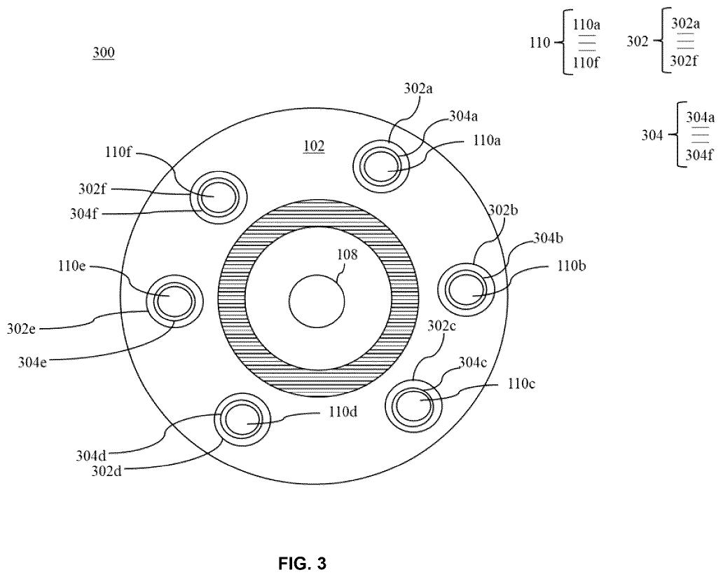

FIG. 3 is a pictorial snapshot illustrating a cross-sectional view of yet another multicore fiber 300. The multicore fiber 300 may be structurally and functionally similar to the multicore fiber 200 of FIG. 2, however, the one or more non-central core regions 110 of the multicore fiber 300 may be trench assisted non-central core regions and the central core region 108 may be a non-trenched core region. In particular, the multicore fiber 300 has the trench region 104 disposed in the cladding region 102. Moreover, the one or more non-central core regions 110 i.e., the first through sixth non-central core regions 110a-110f may be surrounded by one or more non-central core trench regions (i.e., core trench regions) 302 i.e., first through sixth non-central core trench regions 302a-302f, respectively. Further, the multicore fiber 300 may have one or more buffer regions 304 i.e., first through sixth non-central buffer regions 304a-304f disposed between the first through sixth non-central core regions 110a-110f and first through sixth non-central core trench regions 302a-302f, respectively.

In accordance with an embodiment of the present invention, the one or more non-central core trench regions 302 may have a non-central core trench relative refractive index (Δ_{non-central core trench}), non-central core trench radius (R_{non-central core trench}), and non-central core trench alpha (α_{non-central core trench}). Alternatively, the one or more non-central core regions 110 may have a non-central core alpha (α_{non-central core}), no-central core radius (R_{non-central core}) and non-central core relative refractive index (Δ_{non-central core}). Further, the one or more central core regions 108 may have a central core relative refractive index (Δ_{central core}), central core radius (R_{central core}), and central core alpha (α_{central core}),

In accordance with an embodiment of the present invention, the non-central core trench relative refractive index may be in a range of −0.25% to −0.4%. In particular, the multicore fiber 300 having the non-trenched central core region and trench-assisted non-central core region exhibits significant reduction in the crosstalk along with resulting in all the optical characteristics of the multicore fiber 100. Further, the multicore fiber 300 having trench-assisted non-central core regions 110 and non-trenched central core 108 may depict the attributes specified in Table 2.

TABLE 2

| | | | |
|---|---|---|---|
| Attributes | Example 1 | Example 2 | Example 3 |

| Δ_{central core} | 0.6% | | 0.62% | | 0.55% | |
|---|---|---|---|---|---|---|
| R_{central core} | 4.8 | μm | 5.1 | μm | 5 | μm |
| α_{central core} | 7 | | 6 | | 8 | |
| Δ_{non-central core} | 0.55% | | 0.55% | | 0.58% | |
| R_{non-central core} | 4.5 | μm | 5 | μm | 5.2 | μm |
| α_{non-central core} | 7 | | 7 | | 7 | |
| Δ_{non-central core trench} | −0.3% | | −0.3% | | −0.25% | |
| R_{non-central core trench} | 12 | μm | 12 | μm | 11.5 | μm |
| α_{non-central core trench} | 6 | | 6 | | 6 | |
| Δ_{trench} | −0.4% | | −0.6% | | −0.45% | |
| R_{trench} | 15 | μm | 13 | μm | 20 | μm |
| T_{trench} | 5 | μm | 4 | μm | 6 | μm |
| R_{clad} | 62.5 | μm | 62.5 | μm | 75 | μm |
| Δ_{clad} | 0 | | 0.005% | | −0.005% | |
| MFD (at 1310 nm) | 8.6 | μm | 9.1 | μm | 8.8 | μm |
| MFD (at 1550 nm) | 9.5 | μm | 9.7 | μm | 9.8 | μm |
| Pitch | 35 | μm | 35 | μm | 40 | μm |
| OCT | 27.5 | μm | 27.5 | μm | 35 | μm |
| Crosstalk (dB/10 | −74 | | −65 | | −56 | |
| km) | | | | | | |
| Zero dispersion | 1315 | nm | 1315 | nm | 1318 | nm |
| wavelength (ZDW) | | | | | | |
| Cable cut-off | 1215 | nm | 1230 | nm | 1235 | nm |

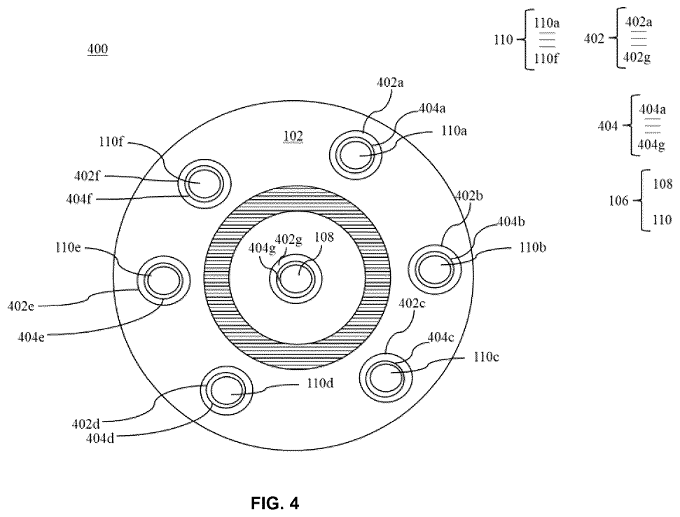

FIG. 4 is a pictorial snapshot illustrating a cross-sectional view of yet another multicore fiber 400. The multicore fiber 400 may be structurally and functionally similar to the multicore fiber 100, 200, 300 of FIGS. 1, 2, 3, respectively. However, the central core region 108 and the one or more non-central core regions 110 of the multicore fiber 400 may be trench assisted central core region and trench assisted non-central core regions, respectively. In particular, the multicore fiber 400 has the trench region 104 disposed in the cladding region 102. Moreover, the central core region 108 and the non-central core regions 110 may be surrounded by a core trench region 402. Further, the multicore fiber 400 may have one or more buffer regions 404 disposed between the core regions 108 and 110 and the core trench region 402.

In accordance with an embodiment of the present invention, the core trench region 402 may have a core trench relative refractive index (Δ_{core} trench), a core trench radius (R_{core} trench), and a core trench alpha (α_{core trench}). Particularly, the core trench relative refractive index may be in a range of −0.25% to −0.4%. Moreover, the one or more non-central core regions 110 i.e., the first through sixth non-central core regions 110a-110f and the central core regions 108 may be surrounded by one or more core trench regions 402 i.e., first through seventh core trench regions 402a-402g, respectively. Further, the multicore fiber 400 may have one or more buffer regions 404 i.e., first through seventh buffer regions 404a-404g disposed between the one or more core regions 110, 108 and the one or more core trench regions 402, respectively.

In accordance with an embodiment of the present invention, the multicore fiber 400 may have the core trench regions 402 disposed adjacent to the one or more core regions 106 such that the multicore fiber 400 is free from any buffer region (i.e., pure silica region) between the core trench regions 402 and the one or more core regions. In particular, the one or more core regions 106 do not have any pure silica region and/or undoped region immediate to the core region, the manufacturing of multicore fiber 400 is less complex while achieving the required waveguide properties along with effectively controlling crosstalk between the cores. Moreover, the absence of the buffer cladding between the core region and the trench region provides better light confinement in the core regions 106. Further, absence of buffer clad region does not avoid the possibilities of very thin buffer region between the core regions and the trench regions which is formed because of uncontrolled process parameters during transitioning phase from the up doped core region to the down doped trench region.

In one or more exemplary aspects of the present invention, the multicore fiber 400 having all the core regions 106 are trench-assisted core regions may depict the attributes specified in Table 3.

TABLE 3

| | | | |
|---|---|---|---|
| Attributes | Example 1 | Example 2 | Example 3 |

| Δ_{core} | 0.55% | | 0.55% | | 0.6% | |
|---|---|---|---|---|---|---|
| R_{core} | 4.5 | μm | 5 | μm | 4.6 | μm |
| α_{core} | 4 | | 8 | | 3 | |
| Δ_{core trench} | −0.4% | | −0.3% | | −0.3% | |
| R_{core trench} | 10 | μm | 12 | μm | 15 | μm |
| α_{core trench} | 6 | | 6 | | 6 | |
| Δ_{trench} | −0.4% | | −0.6% | | −0.45% | |
| R_{trench} | 15 | μm | 13 | μm | 20 | μm |
| T_{trench} | 5 | μm | 4 | μm | 8 | μm |
| R_{clad} | 62.5 | μm | 62.5 | μm | 75 | μm |
| Δ_{clad} | 0 | | 0.005% | | −0.005% | |
| MFD (at 1310 nm) | 8.4 | μm | 8.8 | μm | 8.5 | μm |
| MFD (at 1550 nm) | 9.5 | μm | 9.8 | μm | 9.52 | μm |
| Pitch | 30 | μm | 35 | μm | 40 | μm |
| OCT | 32.5 | μm | 27.5 | μm | 35 | μm |
| Crosstalk (dB/10 km) | −90 | | −85 | | −120 | |
| Zero dispersion | 1316 | nm | 1318 | nm | 1316 | nm |
| wavelength (ZDW) | | | | | | |
| Cable cut-off | 1218 | nm | 1235 | nm | 1224 | nm |

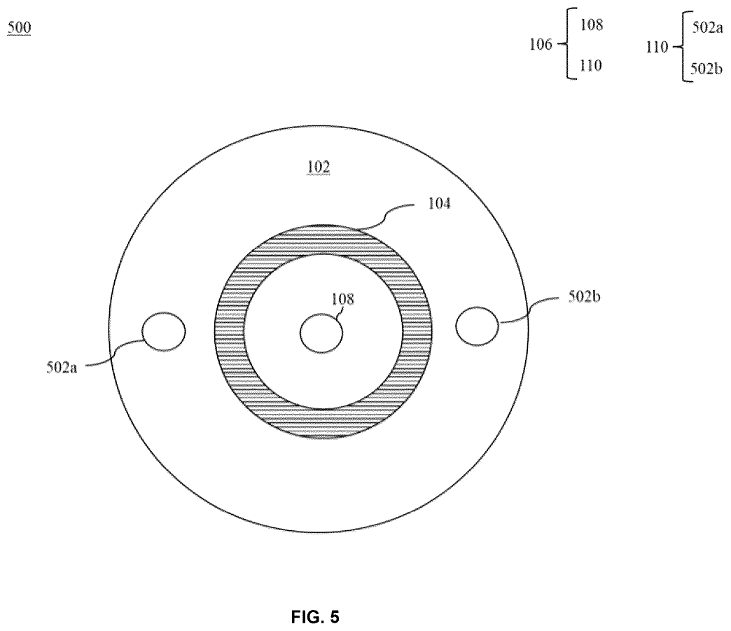

FIG. 5 is a pictorial snapshot illustrating a cross-sectional view of yet another multicore fiber 500. The multicore fiber 500 may be structurally and functionally similar to the multicore fiber 100 of FIG. 1. However, the one or more core regions 106 of the multicore fiber 500 may have three core regions i.e., the central core region 108 and the one or more non-central core regions 110 has first and second non-central core regions 502a and 502b. In particular, the multicore fiber 500 has the trench region 104 disposed in the cladding region 102. Moreover, the central core region 108 and the first and second non-central core regions 502a and 502b may be non-trenched core regions. Further, the one or more core regions 106 having three core regions facilitates to reduce a diameter of the multicore fiber 500 and significantly reduce crosstalk the cladding region 102 has a diameter of 125 μm.

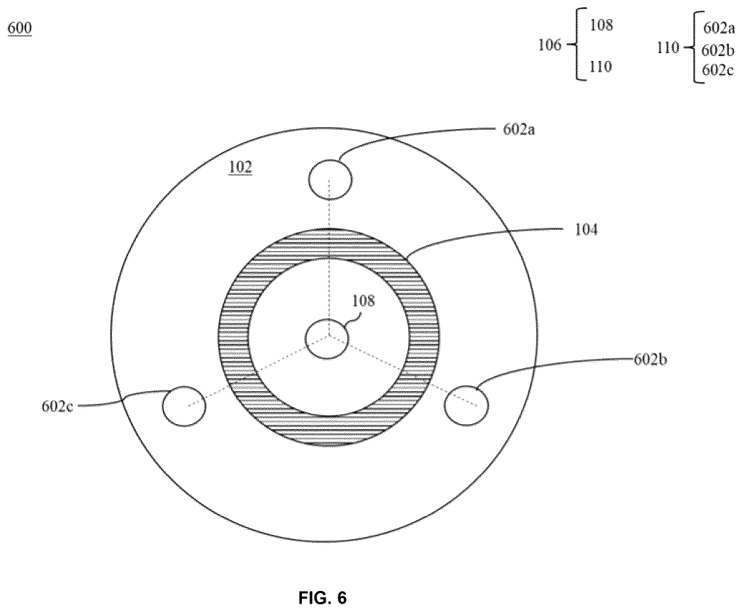

FIG. 6 is a pictorial snapshot illustrating a cross-sectional view of yet another multicore fiber 600. The multicore fiber 600 may be structurally and functionally similar to the multicore fiber 500 of FIG. 5. However, the one or more core regions 106 of the multicore fiber 600 may have four core regions i.e., the central core region 108 and the one or more non-central core regions 110 may have first through third non-central core regions 602a-602c. In particular, the multicore fiber 600 has the trench region 104 disposed in the cladding region 102. Moreover, the central core region 108 and first through third non-central core regions 602a-602c may be non-trenched core regions. Further, the first through third non-central core regions 602a-602c may be configured to form an angle with respect to the central axis of the multicore fiber 600. Furthermore, the angle may be 120 degrees such that the angle of 120 degrees facilitates achieving very low crosstalk in the multicore fiber 600.

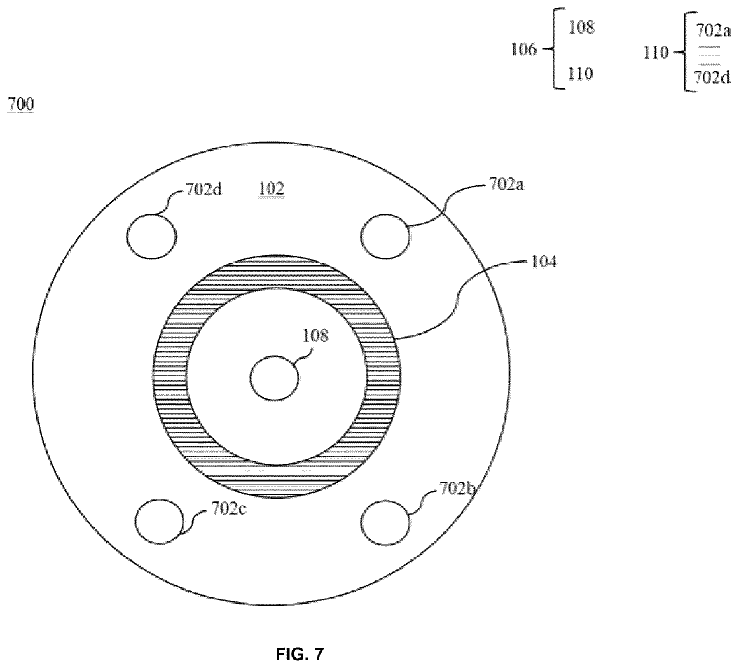

FIG. 7 is a pictorial snapshot illustrating a cross-sectional view of yet another multicore fiber 700. The multicore fiber 700 may be structurally and functionally similar to the multicore fiber 600 of FIG. 6. However, the one or more core regions 106 of the multicore fiber 700 may have five core regions i.e., the central core region 108 and the one or more non-central core regions 110 may have first through fourth non-central core regions 702a-702d. In particular, the multicore fiber 700 has the trench region 104 disposed in the cladding region 102. Moreover, the central core region 108 and first through fourth non-central core regions 702a-702d may be non-trenched core regions. Further, the first through third non-central core regions 702a-702d may be configured to form an angle with respect to the central axis of the multicore fiber 600.

In accordance with an embodiment of the present invention, the angle may be about 90 degrees such that the angle of 90 degrees facilitates achieving very low crosstalk in the multicore fiber 600.

FIG. 8 is a pictorial snapshot illustrating a cross-sectional view of yet another multicore fiber 800. The multicore fiber 800 may be structurally and functionally similar to the multicore fiber 100 of FIG. 1. However, the one or more core regions 106 of the multicore fiber 800 may have 13 core regions i.e., the central core region 108 and the one or more non-central core regions 110 may have first plurality of non-central core regions 802 and a second plurality of non-central core regions 804. In particular, the one or more trench regions 104 may have first and second trench regions 104a and 104b. Moreover, the central core region 108 and the first plurality of non-central core regions 802 and the second plurality of non-central core regions 804 may be non-trenched core regions. Further, the first plurality of non-central core regions 802 may be disposed at a first radial distance from a geometrical centre of the multicore optical fiber 800. Furthermore, the second plurality of non-central core regions 804 may be disposed at a second radial distance from the geometrical centre of the multicore optical fiber 800.

In accordance with an embodiment of the present invention, the second redial distance is less than the first radial distance. In particular, the one or more trench regions 104 may be adapted to isolate the central core region 108, the first plurality of non-central core regions 802 and the second plurality of non-central core regions 804. Moreover, the first trench region 104a may be adapted to isolate the central core region 108 and the first plurality of non-central core regions 802. Further, the second trench region 104b may be adapted to isolate the first plurality of non-central core regions 802 and the second plurality of non-central core regions 804.

Advantageously, the multicore fiber 100, 200, 300, 400, 500, 600, 700, 800 may provide a multicore fiber having a reduced crosstalk, better confinement in the core regions, improved waveguide parameters, and a low leakage loss. Particularly, the multicore fiber 100, 200, 300, 400, 500, 600, 700, 800 enables ease in increasing a number of cores. Moreover, the one or more trench regions 104 isolating the central core region 108, and the one or more non-central core regions 100 may improve the crosstalk of the multicore fiber 100, 200, 300, 400, 500, 600, 700, 800. Further, the one or more trench regions 104 isolates the first plurality of non-central core regions 802 (as shown in FIG. 8), and the second plurality of non-central core regions 804 (as shown in FIG. 8) that facilitates in increasing number of cores in the multicore fiber 800. The one or more trench regions 104 in the cladding region 102 can reduce leakage loss and improves waveguide parameters of each core in the multicore fiber 100, 200, 300, 400, 500, 600, 700, 800.

A person of ordinary skill in the art may be aware that, in combination with the examples described in the embodiments disclosed in this specification, units and algorithm steps may be implemented by electronic hardware, computer software, or a combination thereof.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

In a case that no conflict occurs, the embodiments in the present invention and the features in the embodiments may be mutually combined. The foregoing descriptions are merely specific implementations of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A multicore optical fiber (100, 200, 300, 400, 500, 600, 700, 800) characterised in that:
a cladding region (102) comprising:
one or more trench regions (104) in the cladding region (102); and
one or more core regions (106) such that there is at least one core region on both side (102a, 102b) of the one or more trench regions (104);
wherein the one or more trench regions (104) is not adjacent to the one or more core regions (106).

2. The multicore optical fiber (100, 200, 300, 400, 500, 600, 700, 800) of claim 1, wherein the one or more core regions (106) comprising a central core region (108) and one or more non-central core regions (110).

3. The multicore optical fiber (100, 200, 300, 400, 500, 600, 700, 800) of claim 1, wherein the one or more trench regions (104) separates the central core region (108) and the one or more non-central core regions (110).

4. The multicore optical fiber (100, 200, 300, 400, 500, 600, 700, 800) of claim 1, wherein the one or more trench regions (104) and the one or more core regions (106) are separated by a radial distance that is in a range of 5 micrometres (μm) and 10 μm.

5. The multicore optical fiber (100, 200, 300, 400, 500, 600, 700, 800) of claim 1 wherein each core region of the one or more core regions (106) is surrounded by a core trench region (202, 302, 402) adjacent to the core region.

6. The multicore optical fiber (100, 200, 300, 400, 500, 600, 700, 800) of claim 4, further comprising one or more buffer regions (204, 304, 404) disposed between the one or more core regions (106) and one or more core trench regions (202, 302, 402).

7. The multicore optical fiber (100, 200, 300, 400, 500, 600, 700, 800) of claim 1, further comprising one or more peripheral trench regions (112).

8. The multicore fiber (100, 200, 300, 400, 500, 600, 700, 800) of claim 1, wherein the one or more peripheral trench regions (112) envelops the one or more cores regions (106).

9. The multicore optical fiber (100, 200, 300, 400, 500, 600, 700, 800) of claim 1, wherein the cladding region (102) comprising at least one inner cladding region (104a) and an outer cladding region (104b),

10. The multicore fiber (100, 200, 300, 400, 500, 600, 700, 800) of claim 1, wherein the outer cladding region (104b) has an outer cladding thickness (OCT) of less than or equal to 25 μm.

11. The multicore optical fiber (100, 200, 300, 400, 500, 600, 700, 800) of claim 1, wherein the central core region (108) is surrounded by a central core trench region (202) and the non-central core regions (110) are non-trenched.

12. The multicore optical fiber (100, 200, 300, 400, 500, 600, 700, 800) of claim 1, wherein the central core region (108) is non-trenched and the non-central core regions (110) are surrounded by a core trench region (302).

13. The multicore optical fiber (100, 200, 300, 400, 500, 600, 700, 800) of claim 1, wherein a distance between two nearest cores of the multicore optical fiber is in a range of 35 μm to 40 μm.

14. The multicore optical fiber (100, 200, 300, 400, 500, 600, 700, 800) of claim 1, fiber comprising:
a central core region (108);
a first plurality of non-central core regions (802) disposed at a first radial distance from a geometrical centre of the multicore fiber (100, 200, 300, 400, 500, 600, 700, 800); and
a second plurality of non-central core regions (804) disposed at a second radial distance from the geometrical centre of the multicore fiber (100, 200, 300, 400, 500, 600, 700, 800),
wherein the one or more trench regions (104) separates the central core region (108), the first plurality of non-central core regions (802) and the second plurality of non-central core regions (804).

15. The multicore fiber (100, 200, 300, 400, 500, 600, 700, 800) of claim 1, wherein the multicore fiber (100, 200, 300, 400, 500, 600, 700, 800) has a crosstalk of less than or equal to −70 dB per 10 km.

16. The multicore fiber (100, 200, 300, 400, 500, 600, 700, 800) of claim 1, wherein the multicore fiber (100, 200, 300, 400, 500, 600, 700, 800) has a mode field diameter in a range of 8.1 μm to 9.1 μm at 1310 nm.

17. The multicore fiber (100, 200, 300, 400, 500, 600, 700, 800) of claim 1, wherein the multicore fiber (100, 200, 300, 400, 500, 600, 700, 800) has a mode field diameter of 9.5 μm to 13 μm at 1550 nm.

18. The multicore optical fiber (100, 200, 300, 400, 500, 600, 700, 800) of claim 1, wherein the one or more trench regions (104) has a trench relative refractive index in a range of −0.4% to −0.6%.

19. The multicore optical fiber (100, 200, 300, 400, 500, 600, 700, 800) of claim 1, wherein the one or more core trench regions (202, 302, 402) has a core trench relative refractive index in a range of −0.25% to −0.4%.
